(19) United States
(12) Patent Application Publication
(10) Pub. No.: US 2011/0191320 A1
(43) Pub. Date: Aug. 4, 2011

(54) DIGITAL ASSET MANAGEMENT SYSTEM

(75) Inventor: David A. Glover, Omaha, NE (US)

(73) Assignee: GAME PLAN TECHNOLOGIES, INC., Omaha, NE (US)

(21) Appl. No.: 13/019,472

(22) Filed: Feb. 2, 2011

Related U.S. Application Data
(60) Provisional application No. 61/300,721, filed on Feb. 2, 2010.

(51) Int. Cl. G06F 17/30

(52) U.S. Cl. 707/706; 707/825; 707/E17.01; 707/E17.108

(57) ABSTRACT

The present disclosure describes a digital asset management system directed to a portable container, decentralized, and distributed database approach to asset management. The digital asset management system described is also directed to a system that is designed to be format-neutral and compatible with any file formats available in the art. In an implementation, the digital asset management system includes an importer module configured to import one or more files for storage in a storage volume. A metadata module creates metadata for the imported files and attaches the metadata to the imported files. A distributor module configured to direct the one or more files to a container included in the storage volume. The digital asset management system also includes an editor module configured to create a compressed proxy version of an original source file of at least one of the files for proxy editing.

### CROSS-REFERENCE TO RELATED APPLICATIONS

The present application claims the benefit under 35 U.S.C. §119(e) of U.S. Provisional Application Ser. No. 61/300,721 filed Feb. 2, 2010, entitled DIGITAL ASSET MANAGEMENT SYSTEM.

### BACKGROUND

A digital asset is any form of digital content (e.g., files, etc.) and/or media that have been formatted into a binary source. The digital asset also includes the right to use the digital asset. Digital asset management systems ingest, categorize, archive, maintain, and store the digital assets. Authorized users can interact (e.g., open, edit, review) the digital assets via a computing device, or the like. Digital asset management systems may be implemented in software, hardware, combinations thereof, or the like.

### SUMMARY

The present disclosure describes a digital asset management system directed to a portable container, decentralized and distributed database approach to asset management. The digital asset management system described is also directed to a system that is designed to be format-neutral and compatible with any file formats available in the art. In an implementation, the digital asset management system includes an importer module configured to import one or more files for storage in a storage volume. A metadata module creates metadata for the imported files and attaches the metadata to the imported files. A distributor module configured to direct the one or more files to a container included in the storage volume. The digital asset management system also includes an editor module configured to create a compressed proxy version of an original source file of at least one of the files for proxy editing.

### BRIEF DESCRIPTION OF THE DRAWINGS

The detailed description is described with reference to the accompanying figures. The use of the same reference numbers in different instances in the description and the figures may indicate similar or identical items.

FIG. 1 is an exemplary block diagram illustrating various modules of a digital asset management system in accordance with the present disclosure.

FIG. 2 is an exemplary diagram illustrating various aspects of the digital asset management system in accordance with the present disclosure.

FIG. 3 is an exemplary computing device.

### DETAILED DESCRIPTION

The following description of the disclosure illustrates specific embodiments in which the digital asset management system can be practiced. The embodiments are intended to describe aspects of the disclosure in sufficient detail to enable those skilled in the art to practice the disclosure. Other embodiments can be utilized and changes can be made without departing from the scope of the present disclosure. The present disclosure is defined by the appended claims and the description is, therefore, not to be taken in a limiting sense and shall not limit the scope of equivalents to which such claims are entitled.

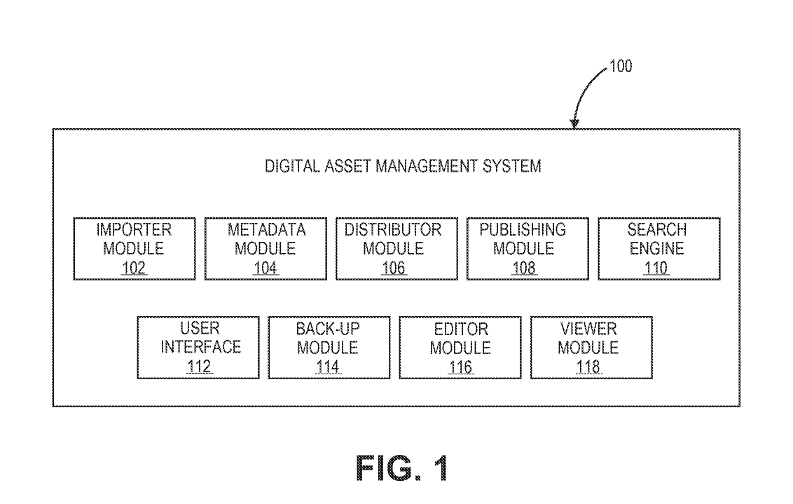

FIG. 1 represents one exemplary digital asset management system 100. System 100 can include various configurations without departing from the functionality set forth in this description. System 100 can be integrated as a combination of software and hardware elements, an operating system or any combination thereof. Hardware, databases, software or applications referenced herein can be integrated as a single module or include various modules in communication with one another. Software and hardware elements are depicted herein for explanatory purposes only and not for limiting the configuration to multiple modules or a single module performing several functions. For example, in FIG. 1, various modules and arrows between modules are depicted for purposes of explaining aspects of functionality and not necessarily for indicating code structure, organization of code, or where code “resides”. It is contemplated that the functionality indicated in FIG. 1 can be located in a myriad of network locations depending on desire, network efficiency, economics, etc. Stated another way, the depiction in FIG. 1 is illustrated as modules to describe the functionality of system 100. The depiction in FIG. 1 of the categorized and named modules is merely for facilitating a logical flow of the description of the functionality of system 100 as set forth herein.

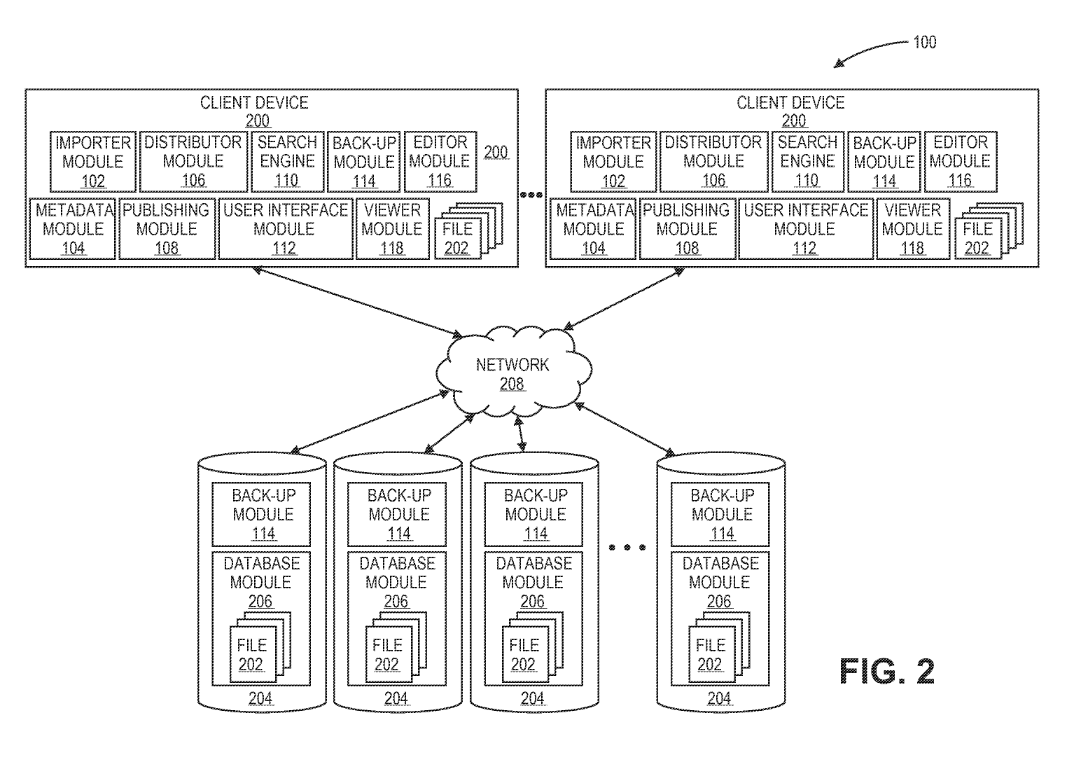

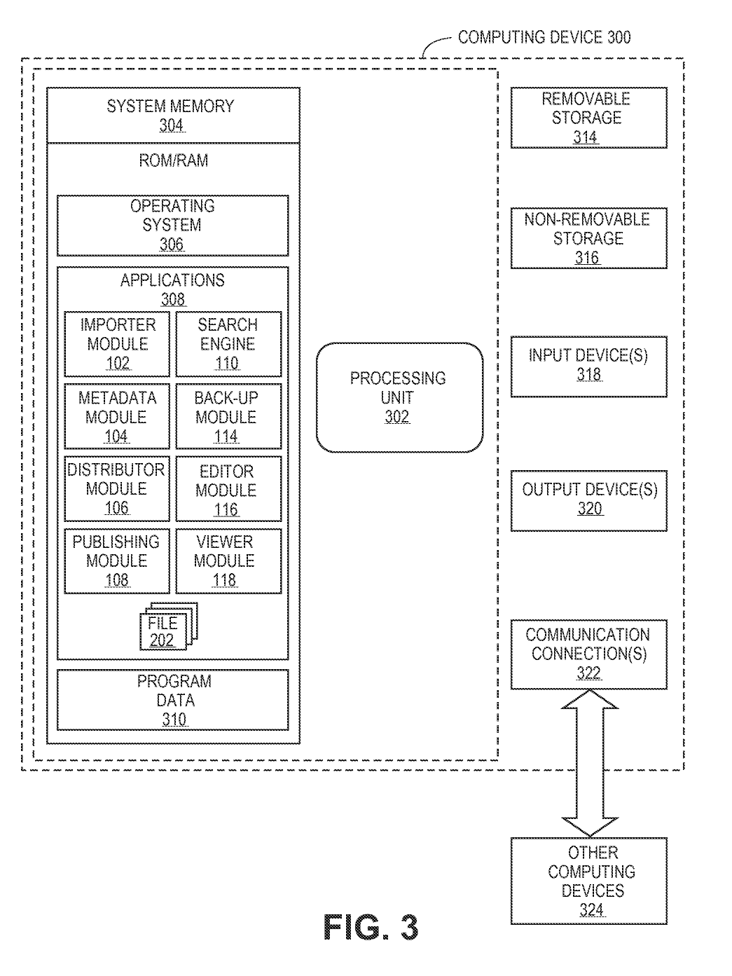

As indicated in FIG. 1, system 100 includes importer module 102 (e.g., importer element), metadata module 104 (e.g., metadata generator), a distributor module 106 (e.g., distributor element), a publishing module 108 (e.g., publishing element), a search engine 110, a user interface 112, a back-up module 114 (e.g., real-time back-up element), an editor module 116 (e.g., editor element), and a viewer module 118 (e.g., viewer element). Elements 102 through 118 can include features of computing device 300 as exemplified in FIG. 3. For instance, as shown in FIG. 2, a client device 200 may comprise a computing device 300, such as a desktop computing device, a mobile computing device, a wireless computing device, a server device, a network server device, a localized server device, and/or any combination thereof.

As shown in FIG. 2, the asset management system 100 is accessed at an individual client device 200 (e.g., computing device 300) and generally includes any combination of the following elements: an importer element 102, a metadata generator 104, a distributor element 106, a publishing element 108, a search engine 110, a user interface 112, a real-time back-up element 114, an editor element 116, a viewer element 118, one or more storage volumes 204, and a database element (e.g., module) 206. The combined elements of this system 100 have the following advantages over asset management systems in the prior art: the system 100 is an open platform that handles virtually any digital content (e.g., files 202, such as digital files, or the like), the system 100 does not require an expensive server or networking, the system 100 does not alter a digital asset (e.g., a file 202) unless new formats are required, it creates and converts files 202 to multiple industry standard formats, the system 100 ingests and attaches metadata to all files 202 and maintains the attachment to all conversion to new formats from the original file's 202 sources, the system 100 provides proxy editing of HD video and HD ready distribution without a server, and there is no single point of failure with the system's 100 real-time automated back-up.

Moreover, as illustrated in FIG. 2, the asset management system 100 is a portable container, decentralized and distributed database approach to asset management. The asset management system 100 is directed by a proprietary software application that manages the database element 206 and creates portable data containers on any available data storage volume 204 within a network 208, including the local hard-drives of any computers connected to the network 208. The network 208 may comprise a wired network, a wireless network, combinations thereof, or the like. The asset management system 100 can be integrated to work with a central client server; however, the container approach of the asset management system 100 allows users to function as if a traditional central client server is being used, but instead, the data assets are actually dispersed throughout all the available storage volume 204 that is within the network 208. The system's 100 use of all available storage volume 204 dispersed throughout the network 208 can eliminate the need and expense of purchasing and maintaining a central client server. The data approach allows for off-line editing, conversion, and metadata creation and manipulation that will be synchronized across each database according to the software rules applied.

The asset management system 100 is designed to be format-neutral and compatible with any file formats that are available in the art. As new file types are introduced and become widely used in an art, the asset management system 100 will take advantage of the new technology by plugging in a codec for that video, audio, or other media format. This open systems approach is desirable because the asset management system 100 advances with technology without requiring expensive upgrades, hardware changes, or loss of media capability. File conversion is also an important part of the asset management system of the present disclosure. The asset management system 100 adapts to new file formats because, regardless of how the media was initially formatted, once the asset management system 100 plugs in an application or codec that has the ability to read the new file type, then the file can be converted to whatever format the customer requires. For example, video files 202 can be compressed or resized as appropriate without losing the data of the source original like traditional embedded software solutions.

As illustrated in FIGS. 2 and 3, the system 100 may include one or more files 202. The files 202 may comprise digital files, such as digital assets; data files; video files; audio files; original source files; document files; metadata files; proxy files; derivative files; and so forth. For instance, the asset management system 100 is capable of managing the following video file formats including, but not limited to: AVI, MPEG2, MP2V, MPEG4, MP4, DVC Pro HD, HDV, MXF, JFIF, JPEG, VOB, WMV, ASF, MOV, MQV, MOD, QT, QTL, AVCHD, DivX, and any others for which a codec is or becomes available. The asset management system 100 is capable of managing the following audio file formats including, but not limited to: WAV, WM, WMA, MP3, AVI, AAF, PCM, uncompressed, and any others for which a codec is or becomes available. The asset management system 100 is capable of managing the following still photo file formats including, but not limited to: JPG, JPEG, BMP, GIF, PNG, TIF, TIFF, PIC, PICT, QT, QTI, and any others for which an application is or becomes available. The asset management system 100 is capable of managing the following document file formats including, but not limited to: WORD/DOC, PDF, XLS, XLHTML, DOCHTML, HTML, HTM, PPT, PPTHTML, SWF, SPL, ZIP and any others for which an application is or becomes available.

An embodiment of the asset management system 100 includes the ability to import almost any digital file 202 into the system 100 through the importer element 102. The asset management system 100 can import individual files 202, batch import entire collections of files 202, and capture live or import media from multiple industry sources into the data management system 100. Moreover, the importer element 102 is configured to map the network location of each file 202 imported. An embodiment of the importer element 102 of the asset management system 100 may also be configured to convert files 202 imported into the system 100 into a user selected standard format. The importer element 102 provides for the asset management system 100 the ability to standardize all file types of the same type or nature. More particularly, the importer element 102 standardizes the files 202 of the same file type to a selected default file type that is a member of the same type as the files 202. For example, the importer element 102 converts all digital video files 202 imported into the asset management system 100 into the .AVI format when the video files 202 are imported into the system 100, no matter the file type of the source file 202 (e.g., MPEG2, MP2V, MPEG4, MP4, or the like).

An embodiment of the asset management system 100 includes the ability to create data files 202 with specific metadata structures that group digital files in a parent/child and brother/sister reference in the system through the importer element 102. These data structures called ADLs (Asset Data Lists) create associations from the individual file metadata as well as the metatags created by the importer element 102. The ADL also defines the relationship between assets 202 from an importer event. The ADL event in the importer element 102 runs a verification process that performs an exhaustive bit comparison to verify that the file 202 imported and registered in the database element 206 is identical to the source. The importer element 102 uses the process of the verification algorithm to also create a UMID, Unique Media Identifier, which is a calculated hash value that will remain with the source file 202 in the database element 206 for the life of the file 202, insuring that the database element 206 can locate every instance of the source material across multiple storage volumes 204 (e.g., storage devices). The process also creates for each source and transcode UMID that tracks as parent/child any transcode operation or alteration of the source file 202 so that an additional UMID is created that contains the metadata of the source and the newly transcoded or altered media that is a combined hash value of both parent and child. Therefore, in the database element 206, every derivative of the source media can be identified uniquely by its source and new transcoded formats and retrieved or transcoded into additional formats. For instance, the derivative file 202 includes metadata of the original source file 202 and is combined with the UMID generated by the verification algorithm to create a new combined Unique Identifier Hash Value.

An embodiment of the asset management system 100 includes the ability to create data files 202 with specific metadata structures that includes ADL metadata, parent/child metadata from the import element 102, and project metadata known as a PDL, or Project Data List. These data structures called PDLs contain the associations from the individual file metadata, the metatags created by the importer element 102, and the relationship between assets from an importer event and new groupings of digital media assets and all the associated data from import and ADLs. The PDL is used as a container to create unique new projects from the source material or the proxy materials and save it to the database element 206 to be opened on other storage locations, backed up, or shared across a network to other instances of the software without altering the source material (multi-format, multi-file proxy editing is the resulting element).

An embodiment of the asset management system 100 is a derivative software package called FlexView that includes the ability to open ADL and PDL data files with the corresponding metadata and create a Presentation Asset List or PAL. The FlexView software package may be implemented as a viewer module 118. The PAL contains ADL metadata, parent/child metadata from the importer element 102, and project metadata from the PDL. The PDL creates inside the PAL a series of objects that include all of the metadata structures of the ADL and PDL and the metadata of the corresponding media objects whether they are source or proxy digital content. The PAL creation and associated objects does not require moving the media (e.g., moving the original source file of the media from a first container to a second container, etc.) so that the proxy editing structure and benefits stay intact as with other elements. The FlexView PAL launches digital assets in a Hypermedia Player with multiple windows for the display and manipulation of the digital content as well as creates a “playlist” of the objects so that the content can be edited, reordered, manipulated, and shared across a network without altering the source material.

An embodiment of the system 100 may also include a metadata generator 104. The metadata generator 104 generally creates metadata files that are linked to, and associated with, the imported file 202. In an embodiment, the metadata allows the software to store the data in containers that correspond with the metadata so that the data in the asset management system 100 can be easily edited and retrieved within the system 100. An embodiment of the metadata generator 104 allows for the three following general types of metadata to be generated for each file: environmental data project metadata, and custom metadata. Environmental data is scraped from the files 202 themselves, project metadata is created during the import process, and a user can add any desired custom metadata to create more individualized metadata files 202. Custom metadata may also be added and updated within the asset management system 100 application using logging tools included in an embodiment of the metadata generator 104.

The system's 100 distributor element 106 directs and stores the files 202 in the correct destination container as the content is captured or ingested. By moving the media immediately to its correct container location within the asset management system 100, there is little delay for the remote users of the system 100 in accessing and downloading any data files 202 or metadata stored within the system's 100 storage volume 204.

The search engine 110 of the asset management system 100 provides a global query for broad searching within the system 100, as well as filtering tools to sift through all available files 202 on any storage volume 204 or server location within the system 100. For instance, the search engine 110 may receive a search query submitted via a user of the client device 200. The search engine may return one or more results (e.g., one or more files 202) based upon the search query. Embodiments of the present disclosure may also allow searching via a Virtual Private Network (VPN) for remote locations within the system 100.

The asset management system 100 also includes an editor element 116. For most files, the editor element 116 can find files 202 stored within the asset management system 100 allowing users to access files 202 from the storage volume 204 and edit the files 202 on their own client device 200 similar to asset management systems known in the art. In addition, an embodiment of the present disclosure may also include an editor element 116 that provides proxy editing capability. The proxy editing element of the editor element 116 creates a compressed proxy version of an original source file 202 wherein the original source file 202 has a large file size that does not allow it to be easily sent across the network 208 or over the Internet. The compressed proxy files allow a user to easily send the smaller proxy file 202 of the original source file 202 to another user in a different location for editing. During the editing of the proxy file 202, the editor element 116 creates edit notations in a very small edit data file 202 and creates new metadata that also reflects any edits to the original source file 202. The edit data file 202 and revised metadata control the editing, translation, conversion, and distribution of the digital files 202.

Further, in this embodiment including proxy editing, the edit data files and revised metadata create a “derivative sister” file 202 of the original source file 202 without altering the original content of the source file 202. The derivative sister file 202 enables a user to view edits of the original source file 202 or any sister content by applying the edit data file 202 and metadata created in the editor element 116 to the original source file 202 to result in an edited version of the original source file 202 without actually altering the content of the original file 202. This allows for a reduction in the required storage volume within the asset management system because the original source file 202 can be the only file that is in the original high volume format and all edited versions of the source files 202 are present and reflected in the small edit data file 202 and revised metadata files 202 that are linked to and associated with original source file 202 in the asset management system 100.

An embodiment of the editor element 116 allows the asset management system 100 to proxy edit large high definition video files 202 in television news reporting. After recording video footage with a digital video camera, the asset management system 100 in this embodiment will automatically transfer a video file 202 from a storage card or flash drive used by the camera to a client device 200, extract or scrape any user-supplied data from the card, convert the media to create a proxy file 202 of the video in a lower definition file type, and send the smaller proxy file 202 over the network 208 or the Internet to the production team at the station for editing. This reduces and can eliminate the need for news reporters to use expensive satellite feeds for remote reporting as video can be obtained and integrated almost immediately at the station via the network 208 or the Internet through the asset management system 100 using only a digital video camera and a client device 200 (e.g., a laptop computing device with a wireless networking capabilities).

Proxy editing, creating edit data files 202 and revised metadata that reflect the edits, allows for multiple edited versions of the original video footage, for example, one version showing a highlight in a commercial for upcoming news and a more thorough version for more complete highlights during the newscast. Each version only requires the storage of the edit data file 202 and revised metadata for that version. These smaller data and metadata files 202 can then be repeatedly applied to the original video file 202 to obtain the edited version. Traditional asset management systems known in the art would require the multiple edited versions to be stored individually, each in the high-definition video format, on a central client server resulting in substantially increased demand in storage volume.

If proxy files 202 have been generated, an embodiment of the editor element 116 searches for the highest quality media within the asset management system 100 and associates any and all edit notations in the small edit data files 202 to the highest quality original source file 202. The editor element 116 can also scan all the memory within the system 100 to retrieve digital media assets 202 associated with the data file 202 and tie them to each other so all edit files 202 and proxy files 202 are tied to and stored with the original source file 202.

An embodiment of the asset management system 100 may also include a publishing element 108. The publishing element 108 allows for the asset management system 100 to convert data files 202 into particular formats required for different types of media and may also provide the ability to upload the data to specified locations on the web, to another server, or to any client device 200 on the network 208. For instance, the publisher allows a user to deliver the media on demand in whatever format is required with the click of a button. An embodiment of the present disclosure for news and/or television production converts an edited high-definition video file 202 into both a .FIN format that can be posted immediately on a website and an .AVI file 202 to be sent to the production department.

An embodiment of the asset management system 100 may also utilize a back-up element 114 (e.g., a real-time back-up element) to protect and archive all data files 202 within the system 100. The back-up element 114 is file based and redundant. Files are backed-up from any data storage volume 204 within the system 100 automatically to multiple locations (e.g., other storage volumes 204 within the system 100). This results in a back-up element 114 that does not have a single point of failure and is an inexpensive back-up solution for a user's (e.g., an administrator, or the like) archival purposes.

In an embodiment, the asset management system 100 may be implemented by installing the proprietary software on each user's individual client device 200. In another embodiment, the system 100 may be implemented by installing the software on a central client server (not shown) wherein each user can log into the application from the central client server. In addition, the asset management system 100 can be customized for the particular needs of about any industry including, but not limited to: education and e-learning, corporate training and communication, house of worship production, medical digital media asset management, security and training, sports analysis and production, legal recording and archive, television and related post production, network news and web production.

Referring to FIG. 3, an exemplary system includes a client computing device, such as computing device 300. In a basic configuration, computing device 300 typically includes at least one processing unit 302 and system memory 304. Depending on the exact configuration and type of computing device, system memory 304 can be volatile (such as RAM), non-volatile (such as ROM, flash memory, and the like) or some combination of the two. System memory 304 typically includes operating system 306, one or more applications 308, and can include program data 310. In one aspect, applications 308 further importer module 102, metadata module 104, a distributor module 106, a publishing element 108, a search engine 110, a user interface 112, a back-up module 114, an editor module 116, a viewer module 118, and one or more files 202.

Computing device 300 can also have additional features or functionality. For example, computing device 300 can also include additional data storage devices (removable and/or non-removable) such as, for example, magnetic disks, optical disks, or tape. Such additional storage is illustrated in FIG. 3 by computer readable storage medium 314 and non-removable storage 316. Computer readable storage medium can include volatile and non-volatile, removable and non-removable media implemented by, for example, stored computer readable instructions, stored data structures, stored program modules or other stored data. System memory 304, computer readable storage medium 314, and non-removable storage 316 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information and which can be accessed by computing device 300. Any such computer storage media can be part of device 300. Computing device 300 can also have input device(s) 318 such as a keyboard, mouse, pen, voice input device, touch input device, etc. Output device(s) 320 such as a display, speakers, printer, etc., can also be included. All these devices are known in the art and need not be discussed at length here.

Computing device 300 also contains communication connection(s) 322 that allow the device to communicate with other computing devices 324, such as over a network or a wireless network (e.g., network 208). Communication connection(s) 322 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system comprising:
at least one processor;
at least one memory;
an importer module, stored on the at least one memory, configured to cause the at least one processor to import one or more files for storage in a storage volume and configured to map a network location for the one or more files stored in the storage volume, the one or more files including an original source file;
a metadata module, stored on the at least one memory, configured to cause the at least one processor to create metadata for the one or more imported files and attach the metadata to the one or more imported files;
a distributor module, stored on the at least one memory, configured to cause the at least one processor to direct the one or more files to a container of the storage volume; and
an editor module, stored on the at least one memory, configured to cause the at least one processor to create a compressed proxy version of the original source file for proxy editing of the compressed proxy version.

2. The system of claim 1, further comprising a publishing module, stored on the at least one memory, configured to cause the at least one processor to convert one or more data files from a first file type to a second file type; and a search engine configured to return one or more results based upon a search query.

3. The system of claim 2, further comprising a user interface configured to receive the search query.

4. The system of claim 1, further comprising a back-up module configured to generate one or more copies of the one or more files.

5. The system of claim 1, wherein the storage volume comprises a decentralized, distributed storage volume configured to store a first file of the one or more files in a first container of the storage volume and configured to store a second file of the one or more files in a second container of the storage volume, where the first container is distinct from the second container.

6. The system of claim 1, wherein the metadata further comprises at least one of: environmental data scraped from the one or more files; project metadata created during the importation of the one or more files; or custom metadata created by a user.

7. The system of claim 1, wherein the editor module is further configured to create an edit file that includes edit notations and metadata that reflects any edits to the one or more files.

8. A system comprising:
at least one processor;
at least one memory;
an importer module, stored on the at least memory, configured to cause the at least one processor to import one or more files for storage in a storage volume, the one or more files including an original source file;
a metadata module, stored on the at least memory, configured to cause the at least one processor to create metadata for the one or more imported files and attach the metadata to the one or more imported files;
a distributor module, stored on the at least memory, configured to cause the at least one processor to direct the one or more files to a container of the storage volume;
a publishing module, stored on the at least memory, configured to cause the at least one processor to convert the one or more files from a first file type to a second file type; and
an editor module, stored on the at least memory, configured to cause the at least one processor to create a compressed proxy version of the original source file for proxy editing of the compressed proxy version.

9. The system of claim 8, wherein the importer module is configured to cause the at least one processor to create an Asset Data List, the Asset Data List including a Unique Media Identifier for each file of the one or more files created during the importation of the one or more files, the Unique Media Identifier being a hash value that remains with the one or more files for the life of the one or more files.

10. The system of claim 9, wherein the importer module utilizes a verification algorithm to create the Unique Media Identifier.

11. The system of claim 9, wherein the Unique Media Identifier of a derivative file includes metadata of the original source file and is combined with the Unique Media Identifier generated by the verification algorithm from the derivative file to create a new combined Unique Identifier Hash Value.

12. The system of claim 9, wherein the importer module is further configured to cause the at least one processor to create a Project Data List, the Project Data list being a data structure including a relationship between a first file of the one or more files and a second file of the one or more files, the relationship including metadata associated with the first file and the second file.

13. The system of claim 12, further comprising a viewer module, stored on the at least memory, configured to cause the at least one processor to create a Presentation Asset List, the Presentation Asset List including at least one of the Asset Data List, the Project Data List, or metadata created by the importer module.

14. The system of claim 13, wherein the viewer module launches content associated with the Presentation Asset List in a hypermedia player for display and manipulation of the content without moving an original source file of the content from a first container to a second container.

15. The system of claim 14, wherein the manipulation of the content further comprises creating a playlist of the content so the content is editable without altering a source material of the content.

16. The system of claim 14, further comprising a user interface, stored on the at least memory, configured to receive the one or more files.

17. The system of claim 16, wherein the importer module is further configured to cause the at least one processor to import a video file from the user interface and extract user-supplied data associated with the video file, the video file having a first size, and the editor module is further configured to cause the at least one processor to convert the video file into a proxy file, the proxy file having a second size, the second size being smaller than the first size.

18. The system of claim 8, wherein the storage volume comprises a decentralized, distributed storage volume configured to store a first file of the one or more files in a first container of the storage volume and configured to store a second file of the one or more files in a second container of the storage volume, where the first container is distinct from the second container.

19. A digital asset management system comprising:
at least one processor;
at least one memory;
an importer module, stored on the at least memory, configured to cause the at least one processor to import one or more files for storage in a decentralized, distributed storage volume, the one or more files including an original source file;
a metadata module, stored on the at least memory, configured to cause the at least one processor to create metadata for the one or more imported files and attach the metadata to the one or more imported files;
a distributor module, stored on the at least memory, configured to cause the at least one processor to direct the one or more files to a first container of the decentralized, distributed storage volume;
a publishing module, stored on the at least memory, configured to cause the at least one processor to convert the one or more files from a first file type to a second file type;
a search engine configured to cause the at least one processor to return one or more results based upon a search query;
a user interface configured to receive the search query; and
an editor module, stored on the at least one memory, configured to cause the at least one processor to create a compressed proxy version of the original source file for proxy editing of the compressed proxy version.

20. The system of claim 19, wherein the importer module is further configured to cause the at least one processor to convert the one or more files having a same type into a selected default file type that is a member of the same type of the one or more files.
